(19) United States
(12) Patent Application Publication
(10) Pub. No.: US 2017/0293737 A1
(43) Pub. Date: Oct. 12, 2017

(54) METHOD AND SYSTEM FOR PROVIDING PERSONALIZED INTELLIGENT HEALTH CONTENT BASED ON A USER PROFILE

(71) Applicant: YOUR.MD AS, Oslo (NO)

(72) Inventor: Harald JELLUM, Oslo (NO)

(73) Assignee: YOUR.MD AS, Oslo (NO)

(21) Appl. No.: 15/508,447

(22) PCT Filed: Sep. 4, 2015
(86) PCT No.: PCT/NO2015/050153

§ 371 Date: Mar. 2, 2017

(30) Foreign Application Priority Data
Sep. 4, 2014 (NO) 20141071

(51) Int. Cl. G06F 19/00; G06N 3/08

(52) U.S. Cl. CPC G06F 19/3443; G06N 3/08; G06F 19/322; G06F 19/3487

(57) ABSTRACT

The invention relates to a novel way of finding similar diseases/conditions, trends, treatments, research, success stories, news, in heritage, or other risk factors and similarities with other users having the similar issues where all is matched with the user relation, profile, family, environments or other related parameters.

### BACKGROUND ART RELATES TO

### Health Information Databases

Today there are several health information services which contains information about diseases/conditions, medicine, treatments etc. Examples can be WebMD, NHS, UpToDate and others. Typical for these is that are based on a database which often is updated manually through a “content management system” with input from doctors or others with health related competence. These solutions are static which means you can do a search, get a result on exact matches. There are no form of “intelligence” to help you. You get exactly what you have searched for.

### Symptom Checkers

There exist several symptom checkers today. These symptoms checkers let you describe your symptoms typically by selecting your body part where your symptoms are located, and thereafter answering asset of fixed (pre-programmed) questions. Examples are WebMD, iTriage, NHS, and Patient.co.uk. Typical for these solutions are that you are told to visit a doctor or not and how important it is that you do this. These solutions are typically based on a set of preprogrammed questions and rules for the different set of symptoms. This is typical static algorithms based on knowledge from one or few sources. It is a problem that they do not relate this to the users profile, family, environment, and previous interest. These solutions have no form of intelligence based on previous knowledge about the user or from previous usage.

### Search Engines

There exists a lot of health information on internet. The information is typically indexed by search engines in such a way that users can search with keywords to find the best matching website. When searching for symptoms on for example Google you get a list of URL's. These are arranged/sorted by several parameters controlled by the search engine. It is a problem that they have no connection to your health profile, family, previous usage and diseases you have or have shown interest for. It is a problem that there is no form for intelligent based on experience related to the user.

### Electronic Patient Journals

These solutions are based on storing the patient journal electronically and where different professionals and systems can access this from different locations. Lately there have been several initiatives, often restricted by local rules and government. These journals typically contain information written by doctors related to your previous visits. It is a problem that there is no automatic intelligent reuse of this information or connection towards your interest, family or other relations.

### Online Doctors/Forums

The Online Doctors/forums are typical websites where you can ask online doctors for advices. The questions and answers are typically public available for others to read. There are several local players in the market. Examples of this are www.doctoronline.no, www.netdoctor.co.uk. It is a problem that these do not contain any form of intelligence based on previous usage or connection towards your health profile or other relations.

### General

It is a problem that none of the above mentioned solutions contain an intelligent solution which gives new and relevant information based on the users' previous activities, relations or other user related interaction. All of them are merely giving results based on a users' exact search criteria.

### BRIEF DESCRIPTION OF THE INVENTION

The invention provides novel method for finding, based on a search pattern and user profile, potential similar diseases, conditions, trends, treatments, research, success stories, news, in heritage or, risk factors as well as similarities with other users having similar, patterns adapted for use corresponding to the users' defined, profile, family and environment.

The invention will help users to stay updated on their health issues, interest and also follow relevant happenings related to this, in an efficient and intelligent manner on a global scale.

The potential users of the invention is not restricted by global boundaries, and is for all persons who wants to improve their own or others health, or how to be preventive in order to avoid diseases or other unwanted health conditions.

The invention is not restricted by global boundaries, and is for all persons with access to mobile phone, tablets, phablets, PC, Mac or other computer means connectable to internet. The users can be normal healthy persons, patients, relatives, parents, professional or other.

### Achievements Compared To Current Technology

The invention provides a novel method that may provide for a user: information concerning similar diseases/conditions, trends, treatments, research, success stories, news, in heritage or other, such as risk factors and similarities, with other users having similar search patterns and combinations with the users own health profile, family and environment.

The invention will help users to stay updated on information related to their own health interests in an efficient and intelligent manner on a global scale.

### Necessary Resources

The invention provides a novel health information system which uses previous searches, user profile, interest, relation to diseases in combination with an advanced search and matching utility which will provide users with updated information about their health in an efficient and intelligent manner.

### Industrial Utilization

The invention will provide users with a system and method enabling them to stay updated, in an efficient and intelligent manner, on their own health issues, and to be proactive and how to optimize their actions and behavior for best possible treatment. Today 90% of all diseases may be treat by the patients themselves. This can help to save health cost on a global scale.

### DESCRIPTION OF THE INVENTION

Based on the problems described above there is a need for a new and more “intelligent” method for users to stay more updated about their own health. The above problems are addressed by the present invention in the following.

The description of the invention is accompanied by the figures of which:

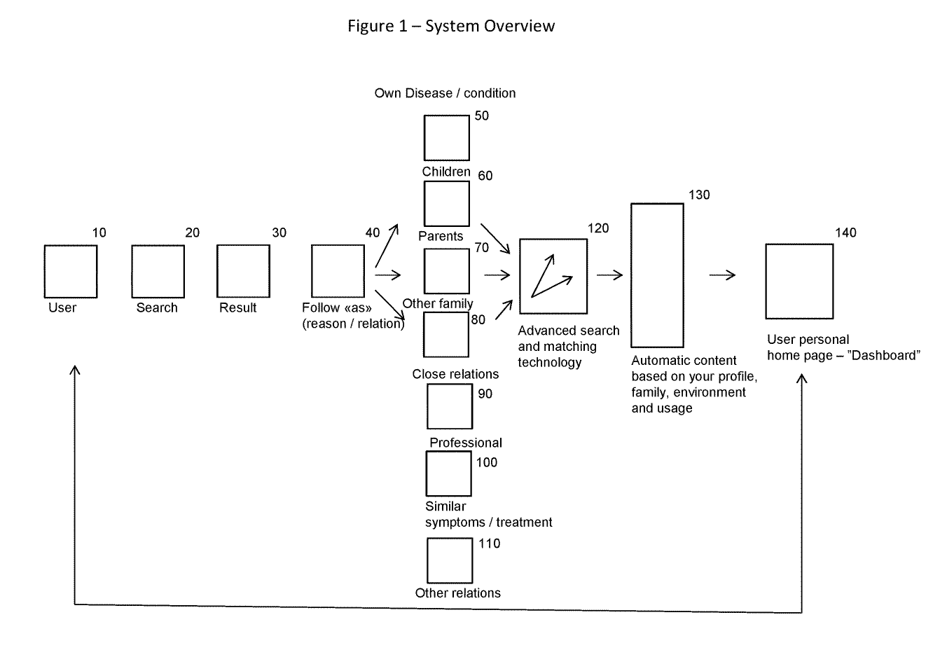

FIG. 1 is a block diagram overview of the system

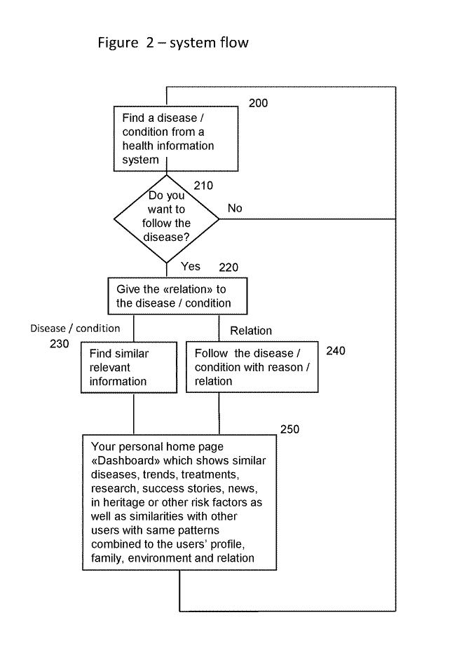

FIG. 2 is a flow chart of the system

Starting with FIG. 1, the invention consisting of a user and computing means 10 where the user can be one of a normal healthy person, patient, relative, professional or other. The user defines search parameters for a search in the health information system 20 of the invention which periodically collected and updated all information from different health sources such as one or more of health registers, health databases, web pages, news, blogs, forum, social networks, or other relevant sources. This search provides a search result 30 comprising possible diseases or conditions. The user may then select to follow the diseases/conditions 40 from the result as one or more of: own disease or condition, children 60, parents 70, other family 80, person in close relation 90, as professional 100, as having similar symptoms 110 or as other relation. This relation selection 50-110 together with the disease/condition is forwarded as a search filter to the advanced search and matching technology 120 utility which then finds other diseases/conditions, news, treatments and similar to the user defined health interest. The advanced search and matching (120) may be search technology using vectors, statistics, semantic, keywords, or other relevant technology which can find similar diseases/conditions or other health relevant health information. These similar diseases/conditions will automatically be fetched out from the same health information database 20 and matched towards the users' profile, family, environment and previous usage 130. These are auto generated health information elements that can be shown in a user personalized—“Dashboard” 140 as for example a list with more related diseases/conditions, symptoms, news, treatments and similar to the specified health interests. The user personalized home page—“Dashboard” may be provided as a mobile App, web site, messages on email, SMS, MMS, or similar, and may further provide a dynamically changeable display format where the users content and presentation may be personalized in one or more of: amount of information, type of information, location, language, colors, layout, font, style, placement/position or other personalized content method.

“Dashboard”(140) content may be shared with others over the network, mobile App, web site, messages on email, SMS, MMS, or similar.

The user health profile, interest and usage behavior may be used by the invention to find other persons with a similar health history/status such that these can be connect for information and experience exchange.

FIG. 2 is showing a flow chart for one alternative embodiment of the invention. It is initiated by a user selecting one or more diseases/conditions provided by a search in the health information system 200. When the user selects a disease/condition to follow 210, the user selects which relation the user shall be associated with for this disease/condition 220. Based on the disease/condition you follow, the system fetches similar disease/condition from the disease/condition database (230). Based on the relation 240, the similar diseases/conditions will be organized as potential similar diseases/conditions, other diseases/conditions with similar symptoms, possible treatment alternatives, success stories, latest news and other related topics in the users' personalized home page —<<Dashboard>> 250. This personal homepage can also be provided as a push service using one of emails, SMS, MMS, mobile applications messages (notifications) or other forms of information exchange.

Other personal parameters in the user profile may include, sex, age, weight, BMI, food preferences and exercise habits, drug habits and medication, cholesterol, triglycerides, family, or other parameters such as environment, location, time, height, weather, travel historic or other may also influence on how the data are presented in the users' personal home page—“Dashboard”.

The present invention comprises a network based server/client service that can be provided over a network such as Internet, Cloud service, WAN, LAN etc. Users representing the client connect s to server services via computing means connected to the server via the network means. The server has access to a plurality of service provider databases, Social medias and other sources comprising health related information. The server environment comprise advanced search and matching technology engines, utilized for updating the content of a proprietary database being part of the search database provided for the clients, as well as for search and filtering requests initiated by the users.

The invention may be implemented on several platforms and solution as Software as a Service(Saas), as a standard portal on internet, as an application for mobile phones, Tablets, Phablets, thin clients, virtual machines, as a local installed solution, as a cloud based service, neural network or any other software based related solution.

The invention is defined by the appended claim set.

1. A method for providing personalized intelligent health content in a health information system, the content being based on a user profile, the user profile may comprising family relation, environment, previous usage of the health information system, by usage of a “follow diseases/condition as” selection comprising one or more relation types, and further by an advanced search and matching operation providing related relevant updated content on a personalized home page of the user, Dashboard, the method further comprising one or more of the following steps:
a) the user searching a first health information database the search resulting in a result listing of potential diseases/health conditions;
b) the user selecting diseases/conditions to “follow as” relations;
c) combining the selected diseases/conditions and the relations, as a search filter in an advanced search an matching technology utility in a second health information database of the health information system to find similar diseases/conditions;
d) combining the found similar diseases/conditions with their relations as relevant content; and
e) presenting the relevant content in the users' personal homepage.

2. The method according to claim 1, where the relations a diseases/condition may be “followed as” may be one of: user disease/conditions, children, parents, other family, person in close relations, professional, similar symptoms or as other reasons/relations.

3. The method according to claim 1, where the user may be one of: a normal healthy person, patient, relative, parents, professional or other.

4. The method according to claim 1, where the result listing of potential diseases/health conditions may be one of: a disease/condition, list of diseases, list of one or more conditions, a filtered list based on different parameters as the user profile comprising parameters such as: sex, age, weight, BMI, food and training habits, drug habits and medication, cholesterol, triglycerides, family or other typical health related parameters as environment as location, time, height, weather, travel history or other relevant parameters.

5. The method according to claim 1, where the “follow as” selection may be as a relation or as a previous user behavior where the user previously has viewed a type of disease/condition, or have read news about a disease/condition, symptoms, treatment or other search patterns representing the users previous usage and interest which can form the basis of a user pattern which provides search patterns for finding other similar diseases, conditions, treatments or other health issues.

6. The method according to claim 1, where the advanced search and matching may be search technology using vectors, statistics, semantic, keywords, or other relevant technology which can find similar diseases/conditions or other health relevant health information.

7. The method according to claim 1, where the personalized home page, Dashboard, may be one or a collection of the user's similar diseases/conditions, other diseases/conditions with the same type of symptoms, possible treatments, success stories, news, social updates, trends or other relevant health information.

8. The method according to claim 1, where the personalized home page, dashboard, may provide a dynamically changeable display format where the users content and presentation may be personalized in one or more of: amount of information, type of information, location, language, colors, layout, font, style, placement/position or other personalized content method.

9. The method according to claim 1, where the user personal homepage, dashboard, may send warnings about new content using one or more of email, SMS, MMS, mobile app messages, social networks messages or other forms of messages.

10. The method according to claim 1, where the user personal home page, Dashboard, may be shared with others.

11. The method according to claim 1, where the user health profile, interest and usage behavior may be used to find and provide information, such as contact information, of other persons with corresponding health history/status.

12. The method according claim 1, where the invention may be implemented on several platforms and solution as Software as a Service(Saas), as a standard portal on internet, as an application for computer, mobile phones, Tablets, Phablets, thin clients, virtual machines, as a local installed solution, as a cloud based service or any other software based related solution.

13. A health information System for providing personalized intelligent health content comprising:
a user client environment comprising computing means, and
a server environment comprising a network service, computing means, one or more databases, search and filtering utilities.

14. The health information System according to claim 13, where user client environment computing means is one of: computer, mobile phone, Tablets, Phablet, thin client, virtual machine.

15. The health information System according to claim 13, where network service is provided by one of a: cloud service, Internet, WAN, or LAN.

16. The health information System according to claim 13, where the server environment provide services and functions as a neural network service.
